(19) United States
(12) Patent Application Publication
(10) Pub. No.: US 2021/0260615 A1
(43) Pub. Date: Aug. 26, 2021

(54) Sprinkler Guard

(71) Applicant: John Tinguely, Albuquerque, NM (US)

(72) Inventor: John Tinguely, Albuquerque, NM (US)

(21) Appl. No.: 17/174,494

(22) Filed: Feb. 12, 2021

Related U.S. Application Data
(60) Provisional application No. 62/980,330, filed on Feb. 23, 2020.

(51) Int. Cl. B05B 15/16

(52) U.S. Cl. CPC B05B 15/16

(57) ABSTRACT

A sprinkler cover comprised of an impact and UV light resistant plastic body that can be placed over an existing sprinkler head is disclosed. The body is comprised of first and second ends, wherein the first end is comprised of an opening to allow for water to exit the sprinkler head while protecting the sprinkler head against debris and impact from an object. The second end of the body is also comprised of an opening to receive the sprinkler, wherein the edges of the body surrounding said opening are comprised of a plurality of serrated teeth to aid in securing the sprinkler cover to the ground. The cover may also be comprised of a transmitter, proximity sensor and a mobile application that allows a user to view the locations of each sprinkler on a property, and a telescoping flag that also allows a user to observe sprinkler locations.

### CROSS-REFERENCE TO RELATED APPLICATION

The present application claims priority to, and the benefit of, U.S. Provisional Application No. 62/980,330, which was filed on Feb. 23, 2020 and is incorporated herein by reference in its entirety.

### FIELD OF THE INVENTION

The present invention relates generally to the field of sprinkler covers. More specifically, the present invention relates to an improved sprinkler cover that is comprised of an impact and UV light resistant body that can be placed over an existing sprinkler head. The body is comprised of a first end and a second end, wherein the first end is further comprised of a continuous opening to allow for water to exit a sprinkler head while protecting the sprinkler head against debris clogging. The second end of the body is further comprised of a continuous opening to receive a sprinkler, wherein the edges of the opening are comprised of a plurality of serrated teeth to aid in securing the protective cover into the ground. In a further embodiment, the protective cover may also be comprised of a Bluetooth transmitter and related mobile application that allows a user (e.g., a maintenance person) to view the location of each sprinkler on a property, and a telescoping flag that allows a user to manually observe sprinkler locations. Accordingly, the present disclosure makes specific reference thereto. Nonetheless, it is to be appreciated that aspects of the present invention are also equally applicable to other like applications, devices and methods of manufacture.

### BACKGROUND

In-ground sprinkler systems are commonly found in both residential and commercial properties alike, and are utilized to ensure that lawns and associated landscaping are adequately watered. Because sprinkler systems are often comprised of a plurality of sprinkler heads that partially protrude above the ground surface, individuals mowing grass may often unintentionally damage or destroy the sprinklers or sprinkler heads by impacting the sprinkler/head with the blade or wheels of lawnmower while cutting grass or other maintenance equipment. The damage oftentimes occurs when the individual mowing the grass forgets or does not realize how close he or she is to the location of a sprinkler or sprinkler head. As such, mower impacts often have a catastrophic effect on sprinkler heads, such that the same are damaged beyond repair and must be replaced, which can be both time consuming and expensive. Further, the impact of the mower blade may further damage the body of the sprinkler, which may then require a total sprinkler replacement, which is also a costly and labor-intensive process. In either scenario, the individual is burdened with additional costs as they must either repair the damaged sprinkler themselves, or hire a professional to complete the task.

Unintentional mower impacts of sprinklers are further prevalent on commercial or residential properties wherein a commercial lawn care service mows the property. In contrast to a homeowner/property owner who may know every location of a sprinkler head on their lawn, commercial lawn care services may not be familiar with a property initially and/or may direct multiple different employees to mow the property each time, such that no employee is particular familiar with, or aware of, the placement of various sprinkler heads on the property. This lack of knowledge about sprinkler head location coupled with increased grass height that may easily obstruct and cover sprinkler heads from the view of the individual mowing, significantly increases the probability that the sprinkler head will be damaged by the mower.

Further, as sprinkler heads are typically the only portion of a sprinkler system that is consistently above-ground, the sprinkler heads are oftentimes exposed to grass clippings, sand, dirt and other debris which may clog the head of the sprinkler, thereby rendering it non-functional. Further, existing sprinkler heads, which are oftentimes comprised of a plastic material, are susceptible to cracking and/or weakening of the material over time due to their continued exposure to UV light in the form of sunlight, wind, rain, snow, sleet and the like. In addition, sprinkler heads may become easily dislodged from the ground via a mower impact or other force such that the entire sprinkler head or cover is dislodged.

Therefore, there exists a long felt need in the art for an improved sprinkler guard or cover that is comprised of an impact resistant material that better protects a sprinkler head and body from unintentional mower and other impact strikes that could otherwise damage the same. There also exists a long felt need in the art for an improved sprinkler guard or cover that is comprised of a UV-light resistant material that better protects a sprinkler head and body from UV-light degradation/damage over time. Further, there is a long felt need in the art for an improved sprinkler cover that prevents grass clippings, sand, dirt, and other debris from clogging the water opening of the sprinkler head, which in turn may prevent proper sprinkler function, and for an improved sprinkler cover that offers a means to better retain a sprinkler cover within the ground, thereby preventing unwanted dislodging of the cover in the event of a mower or other impact. Moreover, there is also a long felt need in the art for an improved sprinkler cover that enables a user to easily and efficiently locate all sprinkler heads on a property, either manually or electronically. Finally, there is a long felt need in the art for an improved sprinkler cover that is relatively inexpensive to manufacture and that is both safe and easy to use.

The subject matter disclosed and claimed herein, in one embodiment thereof, comprises an improved sprinkler cover. The sprinkler cover is comprised of a generally tubular or cylindrical body or housing that is comprised of an impact and UV resistant plastic or other durable material. The body is further comprised of a first end and a second end, wherein the first end is in the form of an end cap having a continuous opening therein that allows water to exit from the sprinkler head while still protecting the sprinkler head from any mower impact, UV-light exposure and/or debris clogging or build-up. The second end of the body is also comprised of an opening that allows the cover to be placed over a sprinkler head, wherein the edges of the body that form the opening are comprised of a plurality of serrated teeth arranged in a radial and spaced apart fashion that allow the body to be inserted partially into, and retained by, the ground.

Additionally, in a further preferred embodiment of the present invention, the cover may also comprise an RFID tag, NFC device, Bluetooth transmitter, etc. that is in communication with a mobile application on a remote device that enables the user to quickly observe the location of each cover (and hence the sprinkler head that it protects) and track the user's proximity thereto while working (e.g., mowing) in any given area. Alternatively, or in addition, the protective cover may also be comprised of a telescoping flag that extends upwardly from the cover and above the grass line so that an individual mowing can easily manually observe the location of each sprinkler head and protective cover and avoid hitting the same.

In this manner, the improved sprinkler cover of the present invention accomplishes all of the forgoing objectives and provides an improved means of protecting a sprinkler from mower and other impacts, as well as UV-light degradation over time. Further, the improved sprinkler cover of the present invention protects sprinklers and sprinkler heads from debris that may otherwise clog the sprinkler and prevent it from functioning as intended. Finally, the improved sprinkler cover of the present invention provides a means to more securely retain the sprinkler cover to the ground in the event of a mower or other impact, in addition to making the sprinkler/sprinkler heads more visible via a mobile tracking application and/or a telescoping flag.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an improved sprinkler cover. The cover is comprised of a generally tubular body that is preferably comprised of an impact and UV-resistant plastic or other suitable material. The body is comprised of a first end and a second end, wherein the first end is comprised of a convex end cap that effectively forms the top surface of the body. The generally convex end cap is also comprised of one or more continuous openings therein that allow water to exit the sprinkler via the sprinkler head, pass through the continuous opening in the cover and be applied to the lawn and/or landscaping as intended. The end cap shields the head of the sprinkler from debris, such as grass clippings, sand, dirt, etc., that may otherwise clog the sprinkler head and prevent it from functioning as intended. In differing embodiments of the device, the end cap may be removably, fixedly, or hingedly attached to the body.

As notes above, the body is also comprised of a second end having an opening therein that allows the protective cover to be slid over an existing sprinkler body. The edges of the second end that form the opening are further comprised of a plurality of serrated teeth that help to anchor the protective cover to the surrounding ground when placed over a sprinkler head. In a differing embodiment of the device, the cover may also be comprised of a hinged bottom surface with a continuous opening to allow for a sprinkler to exit the bottom surface.

In addition, the protective cover may be further comprised of a Bluetooth transmitter that is in wireless communication with a mobile application on a remote device, such as a smartphone. Using the mobile application, a user may view a two-dimensional overhead map of the property, along with the corresponding locations of each sprinkler and cover on the property.

Further, the cover may also be comprised of a proximity sensor that may alert the user via a mobile application alert if the user approaches any sprinkler within a certain proximity distance. The end cap of the protective cover may also be comprised of a telescoping or motorized flag that can be controlled via the mobile application or manually, wherein the flag can extend outwards and upwards from the end cap to be visible above the grass line such that an individual who is mowing the grass can easily observe the flag.

The improved sprinkler cover is particularly advantageous as it provides a more effective means to protect a sprinkler head from mower and other impact damage, as well as overexposure to UV light, which can damage the sprinkler head over time. Further, the improved sprinkler cover ensures that sprinkler head does not become clogged with debris that may interfere with its function, and may be further equipped with a manual and/or electronic locating means.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an improved sprinkler cover device of the present invention in accordance with the disclosed architecture, wherein the improved sprinkler cover device is installed on a sprinkler head;

FIG. 2 illustrates a perspective view of one potential embodiment of an improved sprinkler cover device of the present invention in accordance with the disclosed architecture, wherein the improved sprinkler cover device is installed on a sprinkler head shown in phantom; and

FIG. 3 illustrates a perspective and inverted view of one potential embodiment of an improved sprinkler cover device of the present invention in accordance with the disclosed architecture, wherein the serrations of the lower body portion are fully displayed.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an improved sprinkler cover that is comprised of an impact and UV-light resistant material that protects a sprinkler head and body from mower and other impact strikes, as well as from UV-light degradation/damage. There is also a long felt need in the art for an improved sprinkler cover that prevents grass clippings, sand, dirt, and other debris from clogging the water opening of the sprinkler head, which in turn inhibits proper sprinkler function. Additionally, there is a long felt need in the art for an improved sprinkler cover that offers a user a better means of securing the cover to the ground over the sprinkler head, but that does not impede the flow of water from the sprinkler head to its intended surfaces. Finally, there is a long felt need in the art for an improved sprinkler head cover that is easily identifiable to individuals working in close proximity thereto (e.g., mowing grass, landscaping, etc.), either manually or electronically.

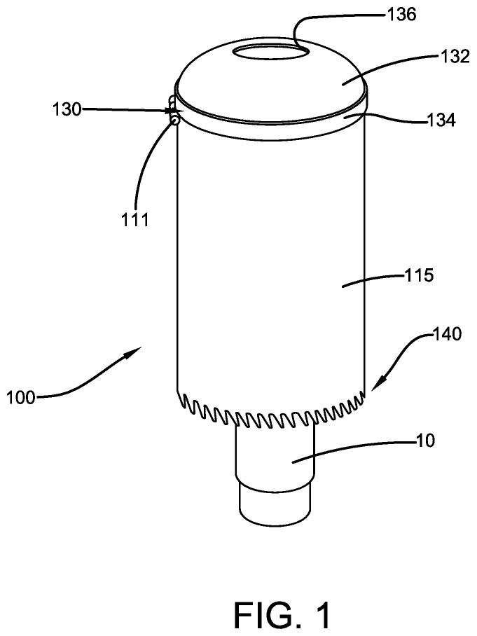

Referring initially to the drawings, FIG. 1 illustrates a perspective view of one potential embodiment of an improved sprinkler cover device 100 of the present invention in accordance with the disclosed architecture, wherein the improved sprinkler cover device 100 is installed on a sprinkler 10. As shown, the cover 100 is preferably comprised of a generally tubular/cylindrical body 110 having a first end 130, a second end 140 and a continuous side surface 115 extending between the first and second ends 130, 140. Nonetheless, the body 110 is not limited to being tubular or cylindrical in shape and, in differing embodiments, the body 110 may be comprised of any other non-geometric or geometric shape including, but not limited to, rectangular, triangular, square, hexagonal, octagonal, oval, etc. Further, the body 110 is preferably comprised of a UV-resistant and impact-resistant plastic that protects the body 110 from UV light damage (e.g. sunlight) and impact strikes from mowers, fertilizers and the like. Notwithstanding, the body 110 is not so limited and in differing embodiments may also be comprised of alternative durable materials, such as stainless-steel, aluminum, fiberglass, etc.

As noted above, the body 110 is comprised of a first end 130 and a second end 140. The first end 130 is comprised of a cap 132 that is preferably convex, half spherical, or dome-like in shape, and integrally formed with, or fixedly or removably attached to, the body 110. For example, in an embodiment wherein the cap 132 is removable from the body 110, the cap 132 preferably has a diameter that is slightly greater than that of the body 110 to create a friction or interference fit between the lip 134 of the cap 132 and the body 110 to secure the cap 132 to the body 110. Alternatively, the cap 132 may be secured to the body 110 via at least one hinge 111, wherein the cap 132 can be extended outwards away from the body 110 to allow for easier insertion of a sprinkler 10/sprinkler head 12 into the body 110. In differing embodiments of the cover 100, the hinge 111 may be comprised of a variety of different hinge types including, but not limited to, an offset blind hinge, knuckle hinge, butt hinge, rising butt hinge, gravity pivot hinge, ball bearing hinge, barrel hinge, concealed hinge, knife hinge, piano hinge, strap hinge, pivot hinge, gas-piston hinge, an injection molded hinge, etc.

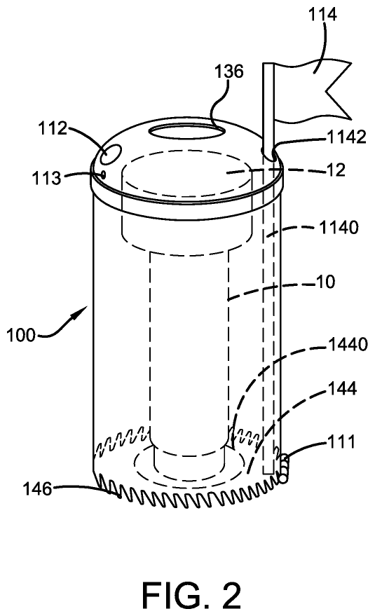

The cap 132 is further comprised of a continuous opening 136 therein that allows the head 12 of a sprinkler 10 to function properly to water a lawn by allowing water that exits the head 12 to exit the cap 132 via the continuous opening 136. However, the cap 132 inhibits debris from entering and clogging the sprinkler head 12 by greatly reducing the exposed area of the head 12 while a sprinkler 10 is inside the cover 100, as best seen in FIG. 2. Notwithstanding, in an alternative embodiment of the cover 100, the cap 132 may be comprised of a plurality of continuous openings 136 that correspond and align with any openings in the sprinkler head 12.

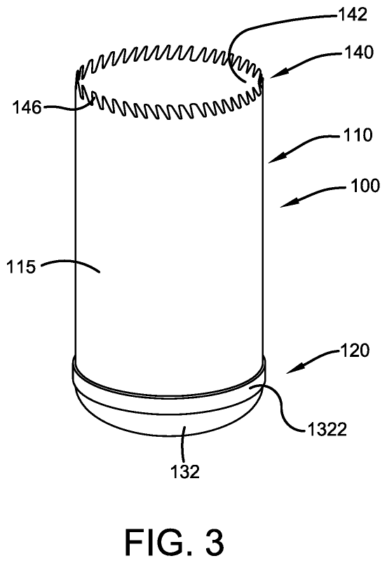

As best shown in FIGS. 1-3, the second end 140 of the cover 100 is comprised of an opening 142 that allows the cover 100 to be easily placed over top of an existing sprinkler 10. More specifically, the body 110 may or may not have a bottom surface provided that the sprinkler head 12 is capable of being inserted through the opening 142 and housed within the cover 100. For example, FIGS. 1 and 3 each illustrate a body portion 110 that is devoid of a bottom surface and rather only has an opening 146.

By comparison, FIG. 2 illustrates a body portion 110 having a bottom surface 144 positioned at the second end 140, wherein the bottom surface 144 comprises a continuous opening 1440 therein that is sized and configured to accommodate the passage therethrough of the sprinkler head 12. Additionally, the presence of the continuous opening 1440 allows the bottom of a sprinkler 10 to extend outwards from within the body 110 to connect to a sprinkler system/water supply (not shown). Further, the bottom surface 144 may be comprised of at least one hinge 111 that connects the bottom surface 144 to the body 110 and that allows the bottom surface 144 to open outwards away from the body 110 to facilitate easier insertion of a sprinkler 10, wherein the bottom surface 144 can then be closed once the sprinkler 10 has been inserted into the body 110. In differing embodiments of the cover 100, the hinge 111 may be comprised of a plurality of hinge types such as, but not limited to, an offset blind hinge, knuckle hinge, butt hinge, rising butt hinge, gravity pivot hinge, ball bearing hinge, barrel hinge, concealed hinge, knife hinge, piano hinge, strap hinge, pivot hinge, gas-piston hinge, injection molded hinge, etc.

In either embodiment of the cover 100 wherein the body 110 may or may not be comprised of a bottom surface 144, the edge of the body portion 110 at the second end 140 is preferably comprised of a plurality of spaced-apart serrated teeth 146. The plurality of serrated teeth 146 are preferably fixedly attached (e.g. integrally formed) to the body 110, but may also be detachable from the body 110 to allow for easy replacement of damaged teeth 146. When separately manufactured, it is contemplated that the plurality of serrated teeth 146 are comprised of the same material as the body 110, which may include, but is not limited, impact/UV-resistant plastic, stainless-steel, aluminum, fiberglass, etc. However, the serrated teeth 146 may also be comprised of a separate, more durable material than the body 110 for increased strength/durability. For example, in one embodiment of the cover 100, the body 110 may be comprised of UV/Impact- resistant plastic and the serrated teeth 146 may be comprised of stainless-steel. The serrated teeth 146 aid in better securing the cover 100 to the ground, such that the protective cover 100 cannot be easily dislodged from the ground and further damaged during a mower impact.

In a further embodiment of the present invention, the protective cover 100 may be further comprised of an RFID tag, NFC chip, or Bluetooth transmitter 112 and a proximity sensor 113, as best shown in FIG. 2. Each of the transmitter 112 and sensor 113 may be positioned anywhere along the body portion 110, but is preferably attached to, or embedded in, the cap 132. Furthermore, the transmitter 112 may be in wireless communication with a mobile application on a smart device (not shown), such as a smart phone, smart watch, computer, tablet or the like. In this manner, the mobile application/smart device automatically displays a two-dimensional overhead view of the property where the user is working and the precise location of each sprinkler 10 such that the user can monitor his or her location relative to each sprinkler 10/cover 100 and avoid striking the same with, for example, a mower, spreader, tractor or the like.

Similarly, the mobile application may track the location of the mobile/smart device and generate an audible alert or push notification when the device (which is presumably on the person of the user) gets within a certain distance of the proximity sensor 113 so that the user can avoid striking and potentially damaging the cover 100 or the underlying sprinkler 10. Stated differently, between the transmitter 112 and the sensor 113, a user (especially an unfamiliar user in the context of a lawn care service) can be aware of each sprinkler 10 location within a lawn to further prevent unintentional mower impacts.

Additionally, in a further preferred embodiment, the cover 100 may be comprised of a motorized flag 114 that is further comprised of a telescoping body 1140 that resides within the cover body 110 when not in use. More specifically, the end cap 132 may be comprised of a second continuous opening 1142 therein that allows the flag 114 to be extended/retracted through the opening 1142 via a control mechanism within the mobile application or manually. In a fully extended/raised position, the flag 114 extends above the sprinkler 10 and above the grass line such that a user mowing can easily physically identity the location of each sprinkler 10, as shown in FIG. 2. In differing embodiments of the cover 100, the flag 114 may be comprised of a plurality of bright colors and or/reflective patterns for easier identification.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “improved sprinkler cover”, “sprinkler cover”, and “cover” are interchangeable and refer to the improved sprinkler cover 100 of the present invention.

Notwithstanding the forgoing, the improved sprinkler cover 100 of the present invention and its various components can be of any suitable size and configuration as is known in the art without affecting the overall concept of the invention, provided that they accomplish the above-stated objectives. One of ordinary skill in the art will appreciate that the size, configuration and material of the sprinkler cover 100 as shown in the FIGS. are for illustrative purposes only, and that many other sizes and shapes of the sprinkler cover 100 are well within the scope of the present disclosure. Although the dimensions of the sprinkler cover 100 are important design parameters for user convenience, the sprinkler cover 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A sprinkler cover for covering a sprinkler, the sprinkler cover comprising:
a first end having a first opening; and
a second end having a second opening, wherein the second end further comprises a plurality of serrations positioned around the second opening.

2. The sprinkler cover of claim 1, wherein the sprinkler cover is comprised of an impact-resistant plastic.

3. The sprinkler cover of claim 1, wherein the sprinkler cover is comprised of a UV light-resistant material.

4. The sprinkler cover of claim 1 further comprising at least one of a transmitter and a proximity sensor.

5. A sprinkler cover for covering a sprinkler, the sprinkler cover comprising:
a tubular body comprised of an impact and UV-light resistant plastic, a first end and a second end, wherein the second end is comprised of an opening that is surrounded by a plurality of serrations;
an end cap positioned on the first end, wherein the end cap is comprised of at least one continuous opening; and
a transmitter in communication with an electronic device.

6. The sprinkler cover of claim 5, wherein the end cap is fixedly attached to the tubular body.

7. The sprinkler cover of claim 5, wherein the end cap is removably attached to the tubular body.

8. The sprinkler cover of claim 5 further comprising a repositionable marker stored in the tubular body when not in use.

9. A sprinkler cover system comprising:
a tubular body comprised of an impact and UV-light resistant material;
an end cap positioned at a first end of the tubular body;
an opening positioned at a second end of the tubular body, wherein the opening is surrounded by a plurality of serrated teeth;
a transmitter;
a proximity sensor;
a telescoping flag repositionable between a first position that is substantially within the tubular body and a second position that is substantially outside of the tubular body; and
an electronic device comprising a mobile application in communication with at least one of the transmitter and the proximity sensor.

10. The sprinkler cover system of claim 9, wherein the end cap is fixedly attached to the tubular body.

11. The sprinkler cover system of claim 9, wherein the end cap is attached to the tubular body via a hinge.

12. The sprinkler cover system of claim 9, wherein the mobile application alerts a user once the electronic device is in close enough proximity to the proximity sensor.

13. The sprinkler cover system of claim 9, wherein the telescoping flag is comprised of a reflective element.

14. The sprinkler cover system of claim 9, wherein the end cap comprises at least two continuous openings therein.

15. The sprinkler cover system of claim 9, wherein the repositioning of the telescoping flag between the first and second position can be done manually by a user.

16. The sprinkler cover system of claim 9, wherein the mobile application can be used to reposition the telescoping flag between the first and second positions.

17. The sprinkler cover system of claim 9, wherein the second end comprised a bottom surface having a continuous opening therein.

18. The sprinkler cover system of claim 9, wherein the plurality of serrated teeth are removable from the tubular body.

19. The sprinkler cover system of claim 9, wherein the plurality of serrated teeth are fixedly attached to the tubular body.

20. The sprinkler cover system of claim 9, wherein the plurality of serrated teeth are comprised of stainless steel.
